(19) United States
(12) Patent Application Publication
(10) Pub. No.: US 2010/0332423 A1
(43) Pub. Date: Dec. 30, 2010

(54) GENERALIZED ACTIVE LEARNING

(75) Inventors: Ashish Kapoor, Kirkland, WA (US); Eric Horvitz, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/490,449

(22) Filed: Jun. 24, 2009

(51) Int. Cl. G06N 5/04; G06N 7/02

(52) U.S. Cl. 706/12; 706/52

(57) ABSTRACT

Active learning is extended to decisions on information acquisition of both missing labels and missing features within one or more cases. In one example, desired (e.g., optimal) information to acquire about a case at hand and about cases in a training library during diagnostic sessions can be computed concurrently. A joint distribution of variables, comprising observed and unobserved labels and features for one or more cases, is modeled and probability distributions are determined for unobserved variables. An unobserved variable is selected from the joint distribution that has a return on information (ROI) metric having a combination of a desired uncertainty metric for a value of the unobserved variable and a desired cost for observing the value of the unobserved variable. The value of the variable is observed, and the probability distributions for the respective unobserved variables in the joint distribution are updated using the value of the identified variable.

### BACKGROUND

There is an abundance of information that can be mined in many different ways. A patient may come to a clinic with one or more salient symptoms that a physician can use for diagnosis. Further, a customer service department may have some information about a customer based on that customer's shopping habits for use in tailoring certain offerings to the customer, for example. Additionally, someone administering a survey may have a certain amount of information about a potential survey taker, based on demographics and/or other information, for example, for use in deciding whether that individual would be a good candidate for polling. These are merely a few examples where learning additional features (e.g., observations) may provide for a more accurate prediction of a label for the case (e.g., diagnosis).

A goal of diagnosis is to predict a value of an unobserved variable (e.g., a know variable having an unknown value), for example, where the variable may be part of a model that captures multiple dependencies among one or more variables, some of which may be observed, such as with the use of a probabilistic graphical model. Active acquisition of information about a presenting case at hand is often critical in diagnosis, where observations already undertaken lead to inference about a probability distribution over different explanations. Such information acquisition can be guided by computing the expected value of information, a measure that for single or sets of additional observations that might be made, balances the value of the information for reaching a better diagnosis with the costs of performing the observations (e.g., medical tests). At the core of probabilistic diagnostic systems is a probabilistic model that generates probability distributions over different hypotheses, and value of information computations make use of such models in computing the ideal observations. Active acquisition of information can also be performed to extend observations about multiple aspects of cases stored earlier in a case library that is used to induce the diagnostic model. Such guided extension of training data is often referred to as “active learning.” Active learning can be used to build improved models that perform better predictions and diagnoses, when used in real time, such as models built from compiled data that are subsequently used to diagnose or determine the likelihood of different situations or outcomes (e.g., for illness, customer service, polling predictions).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, one or more systems and/or methods are introduced which harness computation of the value of information to jointly and concurrently guide the acquisition of missing observations about a situation at hand (or forthcoming situations) and missing data in cases in a case library used to train diagnostic models.

Most applications of machine learning (active learning) rely on training data that comprise completely specified instances, such as having cases with predefined sets of features (observations) and case labels. However, real-world training data may comprise cases with missing case label values and incomplete subsets of feature values, for example, representing a state of observations known about each case when data had been stored in a case library, often with an intent of using it later for building a diagnostic model. Typically, diagnostic or predictor models may be a result of a machine learning procedure. For example, in a medical application, a doctor can attempt a diagnosis based on a patients symptoms. The symptoms can be fed into the predictor model, which can predict an ailment based on a percentage confidence. In this example, the information used for the prediction may have come from an existing database of all patients seen in the past.

However, one may wish to acquire additional information about a case or a situation, for example, to reduce uncertainty about the world or a system. The process of gathering and then folding in consideration of new data can narrow down a number of entities under consideration or refine a probability distribution over hypotheses, for example, to increase the confidence of a final assessment or diagnosis. For example, a doctor may wish to continue the diagnostic process by engaging in a process of active data acquisition, asking additional questions, making additional observations, and ordering additional tests.

Currently, there exists a distinction in theory and in practice between active information acquisition for collecting new observations or evidence during a diagnostic setting (e.g., what is the next -best test to perform to achieve a diagnosis—return-on-information), and information acquisition to increase quality of predictions generated by a model, via collecting information that extends one or more aspects of an existing database of cases that is used to construct diagnostic models.

Techniques and systems are disclosed where active learning/information acquisition at diagnostic time and active learning/information acquisition for a population of cases in a training database can be undertaken at a same time. For example, instead of ordering a new medical test for a patient, as it may be expensive and invasive, a doctor may decide to go out and acquire information from another source to enhance the database of cases used in the diagnostic inference, such as accessing data from another hospital or research facility. In one aspect, it may be less expensive overall to access follow up information on one or more aspects of backgrounds and outcomes of prior cases than to perform a desired test (e.g., next best test) on a patient at hand. For example, diagnosis of a case at hand may be greatly enhanced by expending some effort to fill in some missing data in observations or diagnoses made in several past cases that are in a database used to generate a probabilistic model. Continuing the example, missing data in a case library used for training a diagnostic model may have been expensive or otherwise unavailable to obtain when the case library was developed. However, the observations (e.g., the actual illness that a patient had as confirmed over time with the natural course of an illness) may be available at lower cost at the time of diagnosis. A cost analysis may be performed that can compare testing versus data acquisition to decide a next step (e.g., whether to test or acquire or some combination thereof).

In one embodiment, for extending traditional active learning to decisions on information acquisition of both missing labels and missing features within one or more cases, a joint distribution of variables can be modeled as an undirected graphical model (e.g., a Markov random field). In this embodiment, the joint distribution of variables can be both observed and unobserved labels and features for one or more cases. Probability distributions can be determined for unobserved variables in the joint distribution, and an unobserved variable can be selected from the joint distribution that has a desired return on information (ROI) metric. The ROI can be a combination of an uncertainty metric for a value of the unobserved variable and a cost for observing the value. Additionally, the value of the variable is observed, and the probability distributions for the remaining unobserved variables in the joint distribution can be updated using the value of the identified variable.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart diagram of an exemplary method for extending traditional active learning to decisions on information acquisition of both missing labels and missing features within one or more cases.

FIG. 2 is a flow-chart diagram illustrating one embodiment of a method where data for an unknown variable from a case can be determined.

FIG. 3 is an illustration of databases for three exemplary active learning scenarios, where variables are shown to be observed or unobserved.

FIG. 4 is a flow-diagram illustration a portion of a method where an unobserved variable is identified that can be selected for observation, for example, providing a desired return on information.

FIG. 5 is a component block diagram of an exemplary system that can provide an extension of traditional active learning to decisions on information acquisition of both missing labels and missing features within one or more cases.

FIG. 6 is a component block diagram of one embodiment of a system for active learning that provides information for both diagnosis of test cases and appropriate feature selection to update a predictive model.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

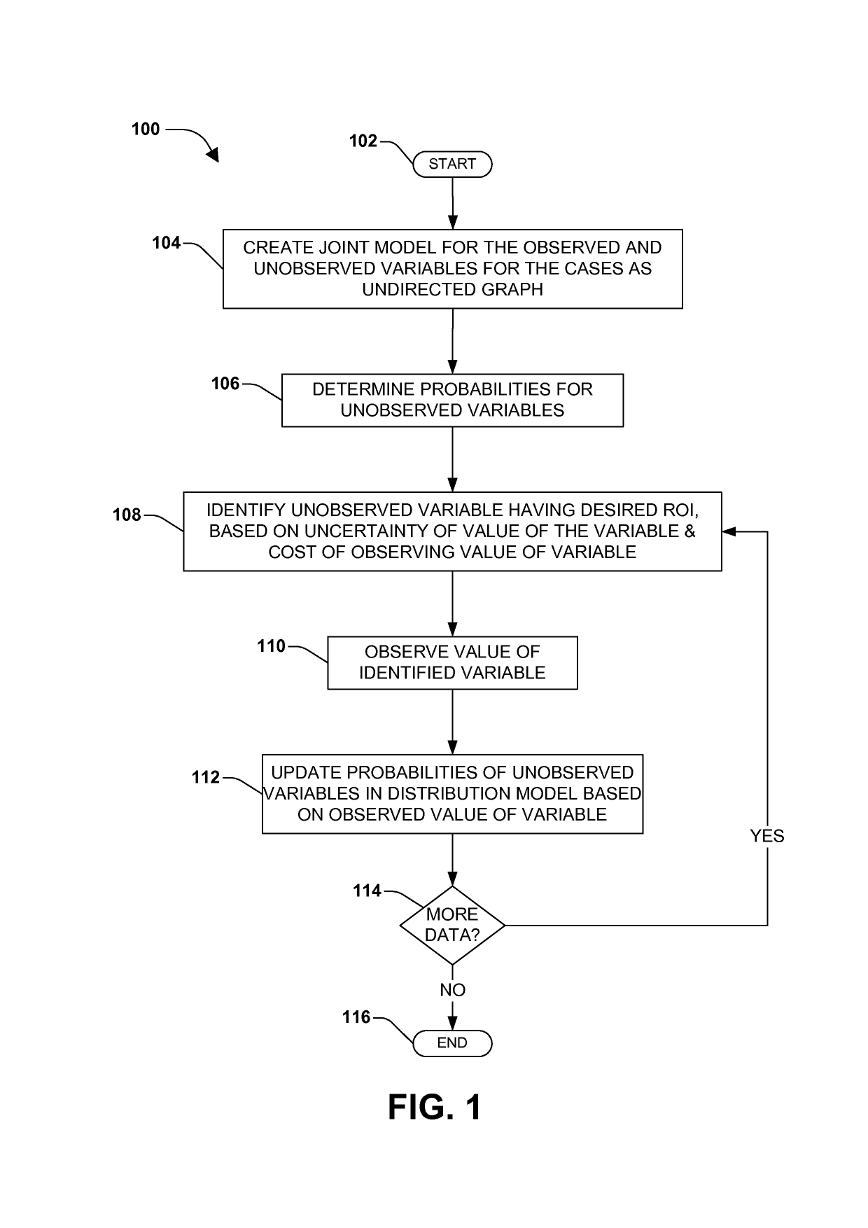

A method may be devised that provides a broad value-of-information analysis to guide decisions, for example, about extension of training sets within incomplete cases (e.g., those with missing labels and/or features (observations)) in active learning scenarios, while returning data that may be useful in diagnosis of test cases. FIG. 1 is a flow chart diagram of an exemplary method 100 for extending traditional active learning to decisions on information acquisition of both missing labels and missing features within one or more cases.

The exemplary method 100 begins at 102 and involves creating an undirected graphical model of a joint distribution of variables, where the variables include observed and unobserved labels and features from one or more cases. In one embodiment, the variables can belong to the respective cases where a set of features for a case comprises predefined observations, and the label comprises a category label for the case. In one embodiment, the labels and features can comprise both observed (e.g., having a known value) and unobserved (e.g., having an unknown value) variables.

Further, the joint distribution of variables can be modeled as a Markov random field, for example, to model the joint density of the features. In his example, this model can provide an effective framework for a conditional model when features are observed and provide appropriate information for missing features when there is incompleteness.

At 106, probability distributions can be determined for respective unobserved variables. For example, respective cases may have both observed and unobserved features and/or labels. In one embodiment, given the observed variables, a probability distribution for the joint distribution can define relationships between the observed and unobserved variables. For example, given an observed feature for a case, the probability distribution may be able to define a probability of an unobserved feature belonging to the same case.

At 108, an unobserved variable can be identified that has a return on information (ROI) metric corresponding to a combination of a desired uncertainty metric for a value of the unobserved variable and a desired cost for observing the value of the unobserved variable. In one embodiment, the unobserved variable that has a desired ROI can be identified. For example, the value of an unobserved is not known; however, based on the probability distributions a measurement of the uncertainty for the unknown variable can be determined. In one embodiment, a likelihood term can be computed for the unobserved variable conditioned on the observed variables. Therefore, a desired uncertainty metric can be one that provides an appropriate level of uncertainty (e.g., optimized).

Further, in one embodiment, a cost for observing the value of the unobserved variable can comprise a variety of subjects. For example, an unobserved variable may be a symptom of some disease, which comprises an unobserved feature. A cost for such a feature may involve testing a patient (e.g., cost of testing and/or cost of the pain and rehabilitation for the patient), and/or the cost may comprise going out and acquiring the data from a source that charges for the information. Therefore, a desired cost for obtaining the data may be one that is appropriate given the circumstances (e.g., least amount in price, resources, time, inconvenience to customer, obtrusiveness, and/or pain and suffering to patient, etc.). In one embodiment, the ROI may comprise a combination of an uncertainty metric that is appropriate for the given cost; and/or a cost that is appropriate for a given uncertainty (e.g., what one is willing to pay for reducing the uncertainty).

At 110 in the exemplary method 100, a value for the variable that was identified (above) as having the desired ROI can be observed. In one embodiment, observing the value of the variable can comprise performing testing to determine the value, such as by experiment, surveys, medical tests, and others. In another embodiment, observing the value of the variable can comprise finding a resource that has the known value of the variable and acquiring the value from that resource, such as buying a database that comprises known values for one or more unknown variable.

For example, in the case of a medical evaluation, in order to narrow down a diagnosis, a doctor can order testing of a patient to identify additional symptoms (e.g., features) of an illness (e.g., labels), such as ordering a biopsy on the patient's tissue. Further, a hospital or research facility may have a database of known symptoms (e.g., case features) and/or illnesses associated with symptoms (e.g., case labels), and the doctor may decide to buy the database to help narrow down the diagnosis.

As another example, a website that offer videos for rent may attempt to offer suggestions on future rentals (e.g., case labels) by gathering observations (e.g., features) about a user. In this example, the website may attempt to observe a feature for the user by testing, such as a survey that the user fills out. Further, the website could also go out a purchase a database that comprises information about the user that was gathered by another source.

At 112 in the exemplary method 100, the probability distributions for the remaining unobserved variables in the joint distribution can be updated using the value of the identified variable. In one embodiment, the probability distributions can be re-calculated for the unobserved variables where the value for the identified variable is added to the respective observed variables to facilitate improving the probabilities. For example, updating the probability distribution may be characterized as active learning, where a new value is learned for a previously unobserved variable and fed back into the classification system to provide improved classification capabilities.

At 114, if more data is requested, for example, in order to help identify additional features or a label for a case, another unobserved variable can be identified, at 108, as described above. However, if no more data is requested, the exemplary method 100 ends at 116.

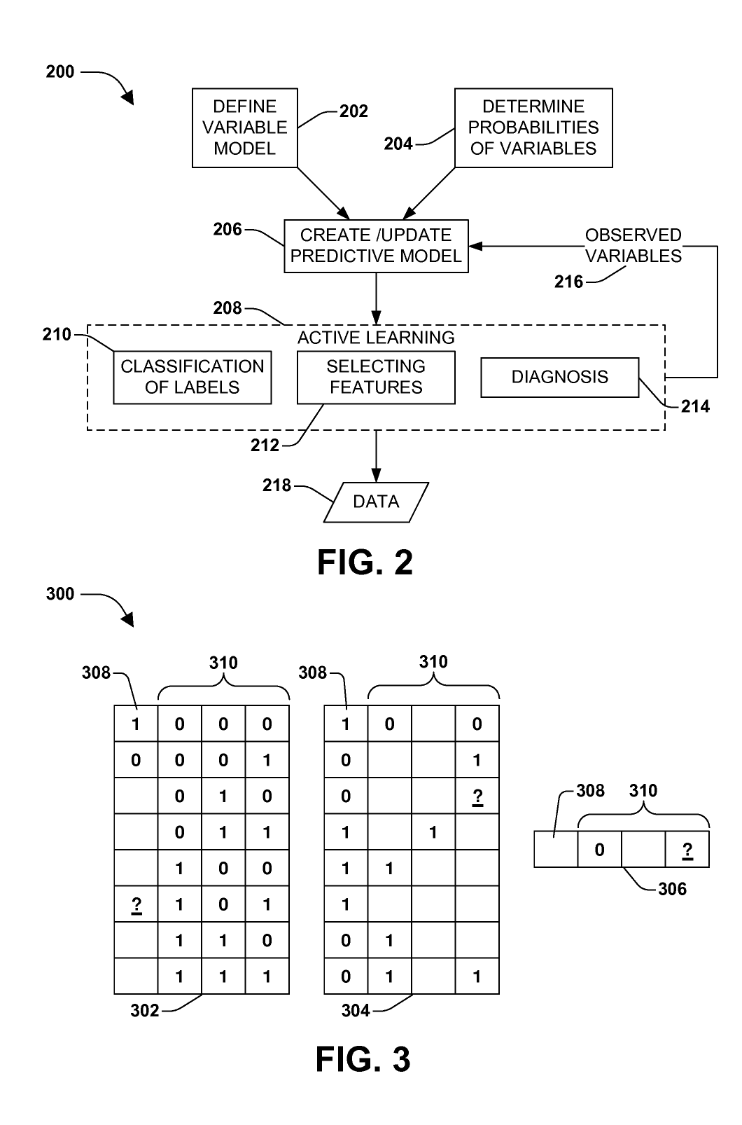

FIG. 2 is a flow-chart diagram illustrating one embodiment 200 of a method where data for an unknown variable from a case can be determined. At 202, a variable model can be defined, as described above, comprising an undirected graph of a joint distribution of the variables, such as the features and labels of a plurality of cases. In this example, the features and labels can comprise both observed (e.g., having a known value) and unobserved (e.g., having an unknown value) variables.

At 204, probabilities for the unknown variable can be determined, such as by computing a likelihood term using a Bayesian classification paradigm. In this embodiment, at 206, a predictive model (probabilistic model) can be created for the unobserved features and labels, which defines relationships between the respective observed and unobserved variables. The predictive model can utilize the probabilities and undirected graph of the joint distribution, for example, to determine probabilities for unobserved label for a case given the observed features for the case. In another example, the predictive model may be able to determine probabilities of an unobserved feature given the observed features and/or observed labels for the case.

In one embodiment, the predictive model is extended beyond traditional conditional models to be modeled as a Markov random field, which can be represented as:

$$p ( D , w , b , v ) = p ( λ ) {\prod }_{i = 1}^{n} \frac{1}{Z ( λ )} exp [ {λ}^{T} φ ( {x}_{i} , {t}_{i} ) ]$$

where, Z(λ) is a partition function that normalizes the joint distribution, λ=[b,w,v] are parameters of the model which comprises a bias (b), a classifier (w), and parameters that can determine compatibilities between observed variables (v). Further, φ(xᵢ, tᵢ)=[t, tx₁, . . . , tx₂, φ(x)] is an appended feature set that can correspond to the underlying undirected graphical model. In this embodiment, the features can be functions of respective individual features of x.

In the exemplary embodiment 200, we are interested in sampling wither a label or a feature value that may provide a desired amount of information (e.g., provide the most information) for a case at hand. The case can define a set of variables (T) for which we may wish to have the desired amount of information about. At 208, different active learning scenarios can be undertaken, for example, depending on which set of variables are observed and unobserved for a given case.

FIG. 3 is an illustration of databases 300 for three exemplary active learning scenarios, where variables are shown to be observed (cells having a 1 or 0) or unobserved (blank cells or those with a ?). At 210, in FIG. 2, classification of labels is performed, for example, where respective features for a case are observed, and a set of T may consist of labels corresponding to respective unobserved variables. For example, in FIG. 3, the grid 302 exemplifies a typical classification of labels scenario. In this example, respective features 310 are all known, and the set of T comprises those six labels 308 that are unknown.

In one embodiment, the identifying of the unobserved variable is performed in order to determine a desired label value to be observed for training the predictive model. For example, if the predictive model were used by a pollster to determine an outcome of some election, they may wish to identify a person's likelihood to vote for a particular issue. In this example, the pollster can identify the label (e.g., the sixth label of 302, in FIG. 3) that gives them a desired level of predictive improvement for their model when the label is observed (e.g., gives them a desired return on information (ROI), given the observed features and labels in the model 302.

At 212 in the exemplary embodiment 200, active learning can be performed for feature selection. The database 304 in FIG. 3 illustrates an example scenario where the respective labels 308 are known, and merely some of the features 310 are known. In this example 304, given the respective labels 308 in the data pool, the active learning may be utilized to select features 310 that create/update an improved predictive model. This scenario can be modeled when the set T comprises the respective unobserved features, and the active learning can select unobserved features to observe, on a case-by-case basis.

At 214 in the exemplary embodiment 200, active learning for diagnosis can be performed. For example, this case can arise when merely a subset of features is observed for a test case, and a label is unobserved, as is illustrated in 306 of FIG. 3. In this example, the set T merely comprises the unobserved test case label 308. As an example, a patient may come to a doctor with only some symptoms (feature) of a disease, and the doctor can decide whether to test for or find information on additional symptoms, or find additional information on the diagnosis (label).

In the exemplary method 200, the variables that are observed 216 can be fed back into the predictive model to update it 206, for example, in order to provide improved predictions for data 218 requested, such as for a diagnosis, poll question, or user preferences.

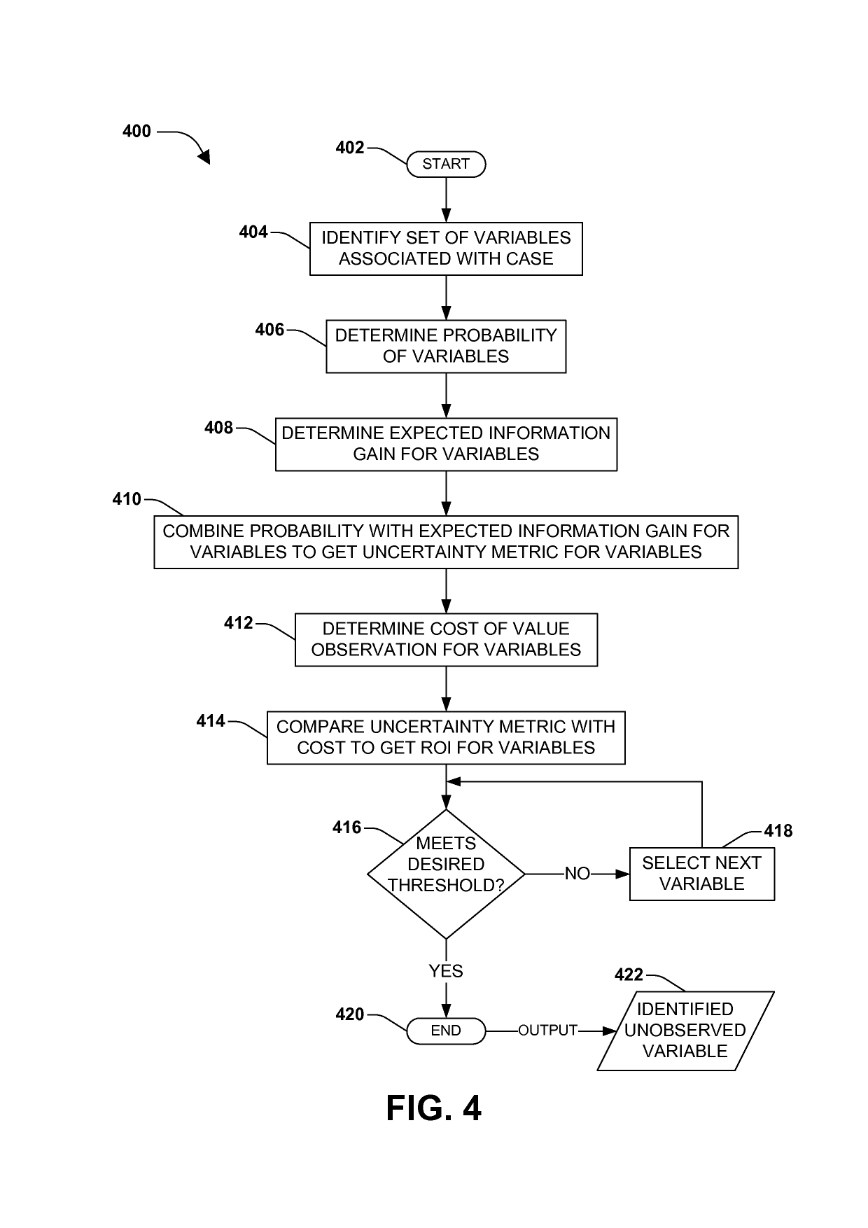

FIG. 4 is a flow-diagram illustrating a portion of a method 400 where an unobserved variable is identified that can be selected for observation, for example, providing a desired return on information (ROI). The exemplary method 400 begins at 402 and involves identifying a set of variable associated with a particular case, at 404, such as illustrated in FIG. 3, as in set T. At 406, the probabilities of the respective variables is determined, as described above, for example, from a predictive model.

At 408, an expected information gain for the set of unobserved variables (T) for the case is determined, which can comprise determining a reduction in uncertainty for T if the selected unobserved variable for the case is observed. For example, if T is the set of unobserved labels 308 in 302 of FIG. 3, the expected information gain for T can comprise the expected improvement in the predictive model for determining the value of the respective labels of T if the sixth label is selected to be observed and fed back to the model (e.g., active learning). In this example, an expected information gain can be determined for the respective variables in T.

At 410, the probability for the respective variables can be combined with their respective expected information gain to determine an uncertainty metric for the respective unobserved variables in the set. For example, the uncertainty metric can compare a given a probability that the variable will return certain information to improve the model, with the expected information gain for the model from observing that variable.

At 412, the cost for observing the value of an unobserved variable can be determined, for the respective variables in the set. In one embodiment, a set of cost related parameters can be defined, such as cost in dollars, cost in resources, cost in time, cost in patient/user/customer inconvenience, etc. Further, the values for the respective cost related parameters can be determined for observing the value of the unobserved variable.

In one embodiment, determining a value for the respective cost related parameters can comprise performing a test to determine the value. In another embodiment, it may comprise using an information source that has a known value for the variable. For example, pollsters or an online website may conduct a test by conducting a survey, which may cost money, time, and cause inconvenience; or a doctor may conduct a diagnostic test, costing money, time, and pain and suffering to a patient. As another example, information about a person may be purchased from someone managing a database of such information; or a doctor may purchase diagnostic information from a clinic, hospital or research facility. Once compiled, the respective parameter costs can be combined to determine a cost for observing the variable's value.

At 414 in the exemplary embodiment 400, an ROI metric can be determined for the respective unobserved variables in the set by comparing the uncertainty metric to the cost for observing the value of the unobserved variable. For example, where cost is of particular concern one may settle for more uncertainty; or where uncertainty is more important, one may be willing to settle for a higher cost in order to achieve less uncertainty. In this way, for example, the ROI can be chosen based on preferences of a user.

At 416, if the ROI for the variable does not meet a threshold, such as a preference of the user, a next variable in the set can be selected, at 418. On the other hand, if the ROI of the identified variable meets a desired threshold, the variable can be selected for observation 422.

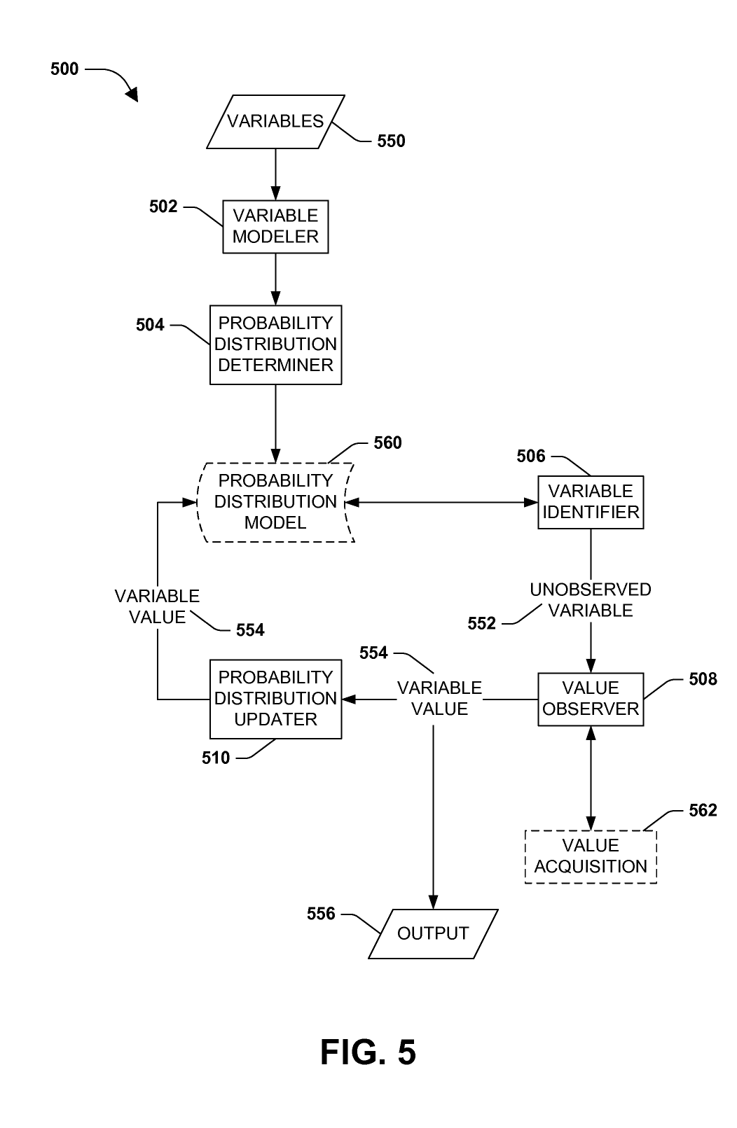

A system can be devised that provides a broad value-of-information analysis to guide decisions, for example, about extension of training sets within incomplete cases (e.g., those with missing labels and/or features (observations)) in active learning scenarios. FIG. 5 is a component block diagram of an exemplary system 500 that can provide an extension of traditional active learning to decisions on information acquisition of both missing labels and missing features within one or more cases.

A variable modeling component 502 models a joint distribution of variables 550 as an undirected graphical model, such as a Markov random field. In this embodiment, the variables comprise a joint distribution of both labels and features for one or more cases, where both observed and unobserved labels and features may be present. A probability distribution determination component 504 determines probability distributions for the respective unobserved variables (e.g., features and labels for which the value is not known) in the joint distribution of variables 550.

For example, the probability distributions for the undirected graphical model of the joint distribution of variables can be used to create a probability distribution model 560. The probability distribution model 560 can define relationships between the variables, such that the observed variables can help define the probabilities for the unobserved variables in the model. In this example, the probability distribution model 560 can be used as a predictive model for the unobserved variables, both for the labels and features, which can be updated with observed variables during active learning.

A variable identification component 506 identifies an unobserved variable (e.g., one with an unknown value) from the joint distribution of variables, for example, selected to be observed. The variable identification component 506 selects a variable that has a return on information (ROI) metric that corresponds to a combined desired uncertainty metric for the selected variable's value and a desired cost for observing the value. A value observation component 508 observes the value 554 of the identified variable 552, for example, by performing a test or acquiring the data from a source having known values for the variables 562.

In one embodiment, the value of the variable may be used for an output 556 of the system, for example, where the variable value comprises some symptom for which medical diagnostic testing was performed (e.g., throat culture test). In this exemplary system 500, a probability distribution updating component 510 can use the value 554 of the (now) observed identified variable to update the probability distributions in the model 560. Using the value of the identified variable 554, the probability distributions for the respective unobserved variables in the joint distribution can be recalculated. In this way, for example, continued active learning can be used to update the predictive model for label and feature classification, while data is acquired for use in diagnosis (e.g., 556).

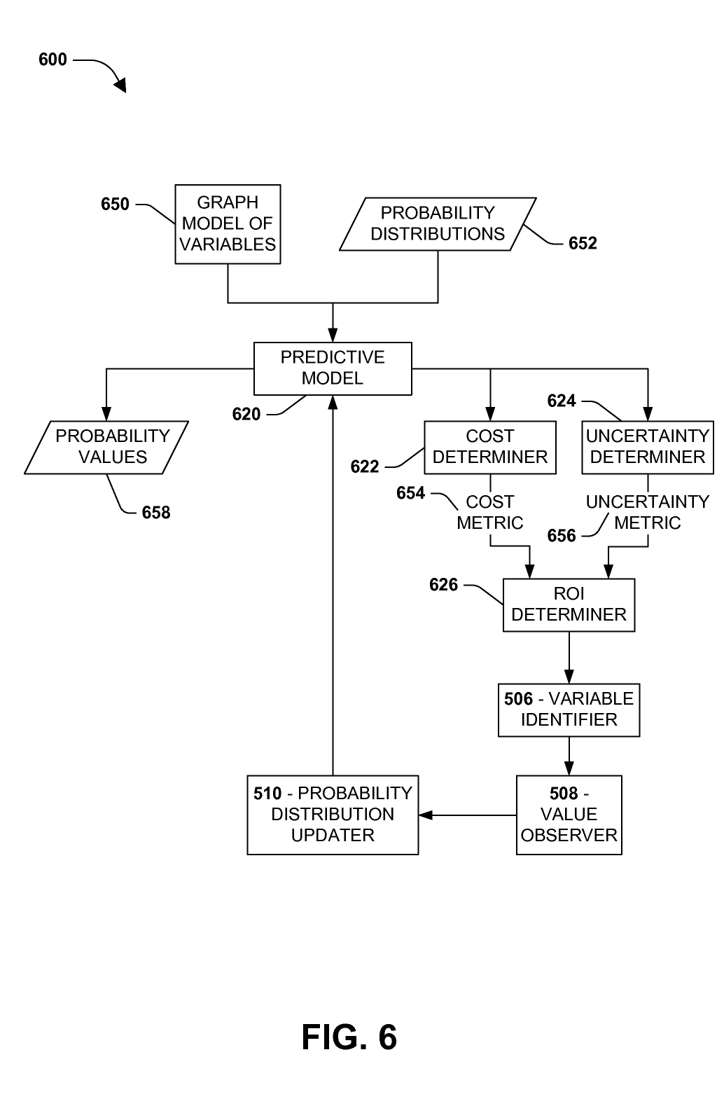

FIG. 6 is a component block diagram of one embodiment 600 of a system for active learning that provides information for both diagnosis of test cases and can for appropriate feature selection to update a predictive model. A predictive model 620 is created by combining the undirected graphical model 650 of the joint distribution of variables with the probability distributions 652 for the unobserved variables in the joint distribution. In this embodiment, the predictive model 620 can determine probability values 658 for unobserved features and labels, for example, based on defined relationships with the observed variables.

An uncertainty determination component 624 can determine uncertainty metrics 656 for unobserved variables (e.g., from a set of unobserved variables for a case). The predictive model 620 can provide probability values 658 for unobserved variables from a set of variables related to a case, and the uncertainty determination component 624 can determine a level of uncertainty of the value of the respective unobserved variables in the set. For example, a level of uncertainty for a first variable in the set may comprise an expected information gain for the other second variables in the set if the first variable is observed.

A cost determination component 622 can determine a cost metric 654 for observing the value of unobserved variables by combining cost some related parameter values for observing the value of the unobserved variable. For example, several costs may be associated with testing for the value (e.g., price, time, inconvenience to customer/patient), and costs may be associated with acquiring the information from a source (e.g., purchasing, time, divulging of information). The cost metric 654 and uncertainty metric 656 can be combined by a ROI determination component 626 to determine a ROI metric for unobserved variables.

The variable identification component 506 can select the unobserved variable for a case from a set of unobserved variables for the case that yields a desired ROI. In one embodiment, the desired ROI can comprise a desired expected information gain for the set of unobserved variables for the case. For example, despite a cost, the expected gain for the remaining variables may be more important. In another embodiment, can comprise a desired cost for observing the value of the unobserved variable for the case. For example, where budgetary constraints may be more important when building a predictive model or database of features and labels.

Once the unobserved variable is identified, the value observer 508 can observe the value for the variables (e.g., by testing or acquiring information). The probability distribution updating component 510 can update the predictive model 620 with the value of the identified variable. In one embodiment, additional data can be acquired for the predictive model, for example, during active learning in order to create a more precise model. Additionally, during active learning, values for missing labels and features may be acquired for diagnosis.

In one aspect, the model can apply to information-gathering for situations where one can consider an extension of a database in context of a current or real-time diagnostic challenge, and where one can use information about a probability distribution over a number and type of forthcoming cases that may be expected based on prior and recent histories. In one embodiment, expectations about forthcoming diagnoses can be used to invoke continual and opportunistic database extension policies that seek out a desired (e.g., optimized) missing data given expectations over the usage of the models constructed from the data.

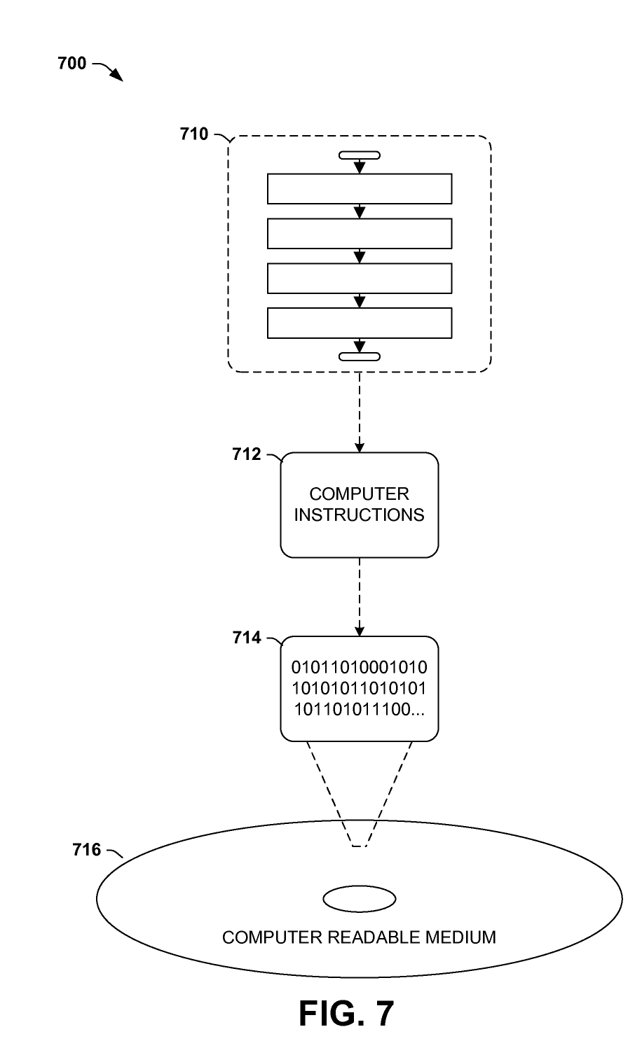

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as the exemplary method 100 of FIG. 1, for example. In another such embodiment, the processor-executable instructions 704 may be configured to implement a system, such as the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

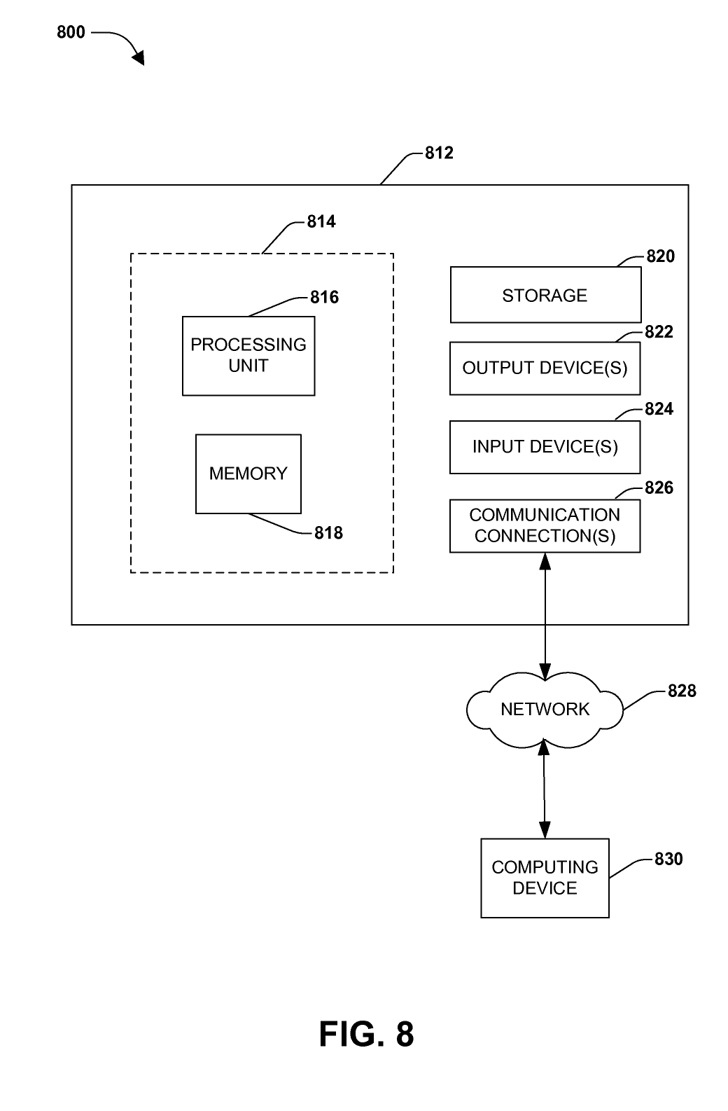

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for active learning that includes decisions on information acquisition of both missing labels and missing features within one or more cases, executed via a processor on a computer comprising a memory whereon computer-executable instructions comprising the method are stored, the method comprising:
modeling a joint distribution of variables, comprising observed and unobserved labels and features, for one or more cases;
determining probability distributions for respective unobserved variables;
identifying an unobserved variable from the joint distribution of variables that has a return on information (ROI) metric corresponding to a combination of a desired uncertainty metric for a value of the unobserved variable and a desired cost for observing the value of the unobserved variable;
observing the value of the identified variable; and
updating the probability distributions for the respective unobserved variables in the joint distribution of variables utilizing the value of the identified variable.

2. The method of claim 1, where the modeling of a joint distribution of variables, comprising observed and unobserved labels and features, for one or more cases is represented with an undirected graphical model.

3. The method of claim 1, determining probability distributions for respective unobserved variables using the undirected graphical model of the joint distribution of variables to create a predictive model for unobserved features and labels.

4. The method of claim 2, identifying the unobserved variable in order to determine a desired label value to be observed for training the predictive model.

5. The method of claim 2, identifying the unobserved variable in order to determine a desired feature value to be observed for making a label prediction for a case using the predictive model.

6. The method of claim 1, identifying the unobserved variable comprising selecting the unobserved variable that has a desired ROI metric.

7. The method of claim 5, comprising determining a ROI metric comprising comparing the uncertainty metric for the unobserved variable to the cost for observing the value of the unobserved variable.

8. The method of claim 5, comprising determining the uncertainty metric for the unobserved variable comprising determining a probability of an unobserved variable from a case given a set of observed variables for the case in the joint distribution of variables.

9. The method of claim 5, comprising determining the uncertainty metric for the unobserved variable comprising identifying an unobserved variable for a case from a set of unobserved variables for the case that yields a desired expected information gain for the set of unobserved variables for the case.

10. The method of claim 8, comprising determining the expected information gain for the set related unobserved variables for the case comprising determining a reduction in uncertainty for the set of related unobserved variables for the case if the selected unobserved variable for the case is observed.

11. The method of claim 5, comprising determining the cost for observing the value of the unobserved variable comprising:
defining a set of cost related parameters;
determining a value for the respective cost related parameters for observing the value of the unobserved variable; and
combining the respective cost related parameters' values to determine the cost for observing the value of the unobserved variable.

12. The method of claim 1, observing the value of the identified variable comprising one of:
performing a test to determine the value of the identified variable; and
using an information source having a known value for the identified variable.

13. The method of claim 11, determining a value for the respective cost related parameters for observing the value of the unobserved variable comprising one of:
determining a value for the respective cost related parameters for performing a test to determine the value of the identified variable; and
determining a value for the respective cost related parameters for using an information source having a known value for the identified variable.

14. A system for active learning that includes decisions on information acquisition of both missing labels and missing features within one or more cases, comprising:
a variable modeling component configured to model a joint distribution of variables as an undirected graphical model, where the joint distribution of variables comprise observed and unobserved labels and features for one or more cases;
a probability distribution determination component configured to determine probability distributions for the respective unobserved variables in the joint distribution of variables;
a variable identification component configured to identify an unobserved variable from the joint distribution of variables that has a return on information (ROI) metric corresponding to a combination of a desired uncertainty metric for a value of the unobserved variable and a desired cost for observing the value of the unobserved variable;
a value observation component configured to observe the value of the identified variable; and
a probability distribution updating component configured to update the probability distributions for the respective unobserved variables in the joint distribution of variables utilizing the value of the identified variable.

15. The system of claim 14, comprising a predictive model created by combining the undirected graphical model of the joint distribution of variables with the probability distributions for the respective unobserved variables in the joint distribution of variables, and configured to provide for determination of probability values for unobserved features and labels.

16. The system of claim 14, comprising a ROI determination component configured to determine a ROI metric for unobserved variables, comprising a combination of the uncertainty metric for the unobserved variable with the cost for observing the value of the unobserved variable.

17. The system of claim 16, comprising an uncertainty determination component configured to determine the uncertainty metric for the unobserved variable comprising determining a probability of an unobserved variable from a case given a set of observed variables for the case in the joint distribution of variables.

18. The system of claim 14, the variable identification component configured to select the unobserved variable for a case from a set of unobserved variables for the case that yields:
a desired expected information gain for the set of unobserved variables for the case; and
a desired cost for observing the value of the unobserved variable for the case.

19. A method for using an expected value of information to compute a desired next piece of information to gather about one or more diagnostic cases, executed via a processor on a computer comprising a memory whereon computer-executable instructions comprising the method are stored, comprising:
comparing an expected value of acquiring information on extensions to a case library of training data and information known about one or more cases; and
determining a desired next piece of information for the one or more diagnostic cases based on the comparison.

20. A method for active learning that includes decisions on information acquisition of both missing labels and missing features within one or more cases, executed via a processor on a computer comprising a memory whereon computer-executable instructions comprising the method are stored, the method comprising:
modeling a joint distribution of variables, comprising observed and unobserved labels and features, for one or more cases as an undirected graphical model;
determining probability distributions for respective unobserved variables;
creating a predictive model for unobserved features and labels using the probability distributions for respective unobserved variables for the undirected graphical model of the joint distribution of variables;
identifying the unobserved variable comprising selecting the unobserved variable that has a desired return on information (ROI) metric, comprising:
determining an uncertainty metric for the unobserved variable comprising determining a probability of an unobserved variable from a case given a set of observed variables for the case in the joint distribution of variables;
determining the cost for observing the value of the unobserved variable comprising:
defining a set of cost related parameters;
determining a value for the respective cost related parameters for observing the value of the unobserved variable; and
combining the respective cost related parameters' values to determine the cost for observing the value of the unobserved variable; and
determining a ROI metric comprising comparing the uncertainty metric for the unobserved variable to the cost for observing the value of the unobserved variable;
observing the value of the identified variable, comprising:
performing a test to determine the value of the identified variable; and
using an information source having a known value for the identified variable; and
updating the probability distributions for the respective unobserved variables in the joint distribution of variables utilizing the value of the identified variable.
